(19) United States
(12) Patent Application Publication
(10) Pub. No.: US 2026/0257634 A1
(43) Pub. Date: Sep. 3, 2026

(54) ACTUATION OF AN ACTUATOR IN A MOTOR VEHICLE

(71) Applicant: Minebea Mitsumi Inc., Nagano (JP)

(72) Inventors: André SCHUBERT, Ingolstadt (DE); Thomas LIEPOLD, Gaimersheim (DE); Thomas GENSBERGER, Wellheim (DE); Martin WINKER, Wurmlingen (DE)

(21) Appl. No.: 19/553,676

(22) Filed: Mar. 2, 2026

(30) Foreign Application Priority Data
Mar. 3, 2025 (DE) 10 2025 108 004.6

(51) Int. Cl. B60R 16/023; G01P 15/08; G07C 5/08

(52) U.S. Cl. CPC B60R 16/0232; G01P 15/08; G07C 5/0808

(57) ABSTRACT

The actuation of an actuator of a motor vehicle. For this purpose, a predefined trigger pattern of a sensor signal is first detected, depending on an actuation of a sensor of the motor vehicle. In this case, the trigger pattern can be used to actuate the actuator according to a predefined actuation condition. Subsequently, a structure-borne sound signal associated with the trigger pattern is acquired, which signal propagates in a solid body of the motor vehicle. Next, it is checked whether the structure-borne sound signal is present as an interference signal for the actuation of the actuator, according to a predefined interference criterion. Only if the structure-borne sound signal is present as an interference signal, the predefined actuation condition for actuating the actuator is adjusted, and the actuation of the actuator takes place only depending on the adjusted actuation condition.

The disclosure relates to a method for actuating an actuator of a motor vehicle. Furthermore, the disclosure relates to a control device for a motor vehicle for actuating an actuator of the motor vehicle.

### BACKGROUND

Modern motor vehicles have operating units that can be actuated to control and thereby actuate an actuator of the motor vehicle. Such operating units are known from the prior art.

For example, DE 10 2011 011 802 A1 discloses a user interface of a vehicle with a touch-sensitive control unit. In this case, an operating movement is acquired and subsequently, if necessary, an actuation of the control unit is corrected if the operating position slips during the operating movement, for example due to a pothole.

DE 10 2014 206 831 A1 discloses a possibility for operating an operating system, for example in a vehicle. In this case, interfering movements within the vehicle are taken into account during input and subsequently compensated for. The interfering movement occurs, for example, due to vehicle body movements or fluctuations of an operator's arm.

DE 10 2013 215 742 A1 discloses an operating device for operating an electronic device via a touchscreen. In this case, an acquired position signal with respect to a touch position on the touchscreen is filtered depending on interference movement data identified by means of acceleration sensors.

The prior art therefore relates to correcting an operator's input, for example using acceleration sensors, and thus to ascertain an actually desired position for the input on an operating unit.

However, there are also situations in which, regardless of the operating position, incorrect operation of a corresponding operating unit can occur, for example due to environmental influences or influences from the surroundings. This can occur, for example, in a car wash. Due to vibrations exerted on the motor vehicle by the car wash, sensors or switches and buttons that are coupled with corresponding sensors, such as capacitive door handles, rain sensors and other sensors, may trigger incorrectly or unintentionally. These sensors are used as operating units for actuating or controlling a corresponding actuator of the motor vehicle, such as a windshield wiper, or a door, or a trunk. The sensors are now unable to distinguish between washing brushes and rain or an input from an operator. The sensors, switches and buttons are therefore installed in a hidden or protected manner, so that they are not automatically also cleaned during the cleaning process, for example.

### SUMMARY

The object of the present disclosure is to prevent incorrect operation during actuation of an actuator of a motor vehicle, due to environmental influences.

According to one aspect, the disclosure relates to a method for actuating an actuator of a motor vehicle. In the method, a predefined trigger pattern is first detected in a sensor signal, depending on an actuation of a sensor in the motor vehicle. In this case, the trigger pattern can be used to actuate or activate the actuator according to a predefined actuation condition. Therefore, if the trigger pattern meets the predefined actuation condition, which is the case, for example, in a normal operating mode of the motor vehicle, the trigger pattern is used to actuate the actuator.

The trigger pattern is therefore in particular a signal component or portion in the sensor signal which, if it is recognized or detected by a control device, for example, can be used for actuating the actuator. The conditions under which the trigger pattern leads to the activation of the actuator are stored in the actuation condition. For example, a predefined pattern or sequence may be provided in the actuation condition, which pattern or sequence is predefined or stored as a trigger sequence for activating the actuator. Additionally or alternatively, for example a trigger threshold can be stored in the actuation condition, which, if exceeded (i.e., if a value of the trigger pattern exceeds this threshold), leads to the actuation of the actuator.

Next, in the method, a structure-borne sound signal associated with the trigger pattern is acquired, which signal propagates in a solid body of the motor vehicle. "Associated" means, here, that the structure-borne sound signal possibly occurs within a predefined time interval relative to the trigger pattern, i.e., relative to the sensor signal. Possibly, the structure-borne sound signal and the trigger pattern overlap temporarily, in particular they occur simultaneously.

The structure-borne sound signal can be caused for example by vibrations that occur when the motor vehicle is in a car wash. Additional or alternative causes for the structure-borne sound signal could be, for example, heavy rain or hail, music played in the vehicle, or, for example, a ball being played against the vehicle. Of course, other causes are also possible, which could generate a corresponding structure-borne sound signal in the solid body of the vehicle.

A check is subsequently made, in the method, as to whether the structure-borne sound signal is present as an interference signal, according to a predefined interference criterion, for activating the actuator. That is to say that a check is made as to whether the structure-borne sound signal could represent an interference for the actuation. This is the case, for example, if the structure-borne sound signal contains a signal component that could be recognized as a trigger pattern for actuating the actuator. In order to evaluate the structure-borne sound signal for checking against the interference criterion, for example a frequency analysis or an RMS algorithm (RMS: Root Mean Square) can be performed. Alternatively or additionally, integration over time or acquisition of a root mean square of the structure-borne sound signal, or a similar evaluation method, is conceivable.

Only if the structure-borne sound signal is present as an interference signal, i.e., was detected as an interference signal and thus fulfills the interference criterion, is the predefined actuation condition for actuating the actuator adjusted, i.e., changed. The actuator is then actuated depending on the adjusted actuation condition. Possibly, the previous trigger pattern in the sensor signal, which fulfilled the originally predefined actuation condition, can therefore no longer be used to actuate the actuator. In particular, the previously predefined trigger pattern therefore does not meet the adjusted actuation condition. If, however, the interference signal is not present (interference criterion is not met), the previous actuation condition is retained.

The disclosure therefore relates to recognizing an unwanted actuation of a sensor, for example in a car wash, which is detected, for example, by the structure-borne sound that is coupled into the bodywork and thus indirectly into the sensor by washing brushes. If such an unwanted input is acquired, the conditions for the actuation of the actuator, i.e., when the actuator is activated or triggered at all, are changed. In this case, the change is made in particular in such a way that the structure-borne sound, i.e., in particular the interference signal, no longer leads to the actuation of the actuator. This makes it possible to effectively prevent unwanted actuation of the actuator. The mode in which the adjusted operating condition is used is also called the interference mode.

The sensor according to the disclosure can be, for example, a door sensor, in particular a capacitive door sensor, an inductive sensor, a tactile sensor, a rain sensor, a seismic sensor or another type of sensor for actuation recognition. The sensor in question can, for example, be designed as a force sensor, and/or it can, for example, be a proximity sensor.

The actuator according to the disclosure can be an electrically or electronically controllable vehicle component of the motor vehicle which performs an associated vehicle function when acted upon or controlled with a trigger signal. The actuator can be designed, for example, as a door opening system for a vehicle door and/or tailgate and/or a frunk (front trunk) or as a windshield wiper system. In order to operate the assigned vehicle component, the actuator can, for example, comprise an electric motor or linear motor, or comprise a solenoid valve or a relay.

In one embodiment, actuation of the actuator is prevented according to the adjusted actuation condition. That is to say that, regardless of what the sensor signal looks like, the actuator can no longer be controlled or triggered. In addition, the actuator can, for example, be switched off and/or for example data transmission to the actuator with an actuation signal for actuating the actuator can be blocked or prevented.

In one embodiment, the predefined trigger pattern is adjusted according to the adjusted actuation condition, and the actuator is only actuated if the adjusted trigger pattern is detected in the sensor signal. That is to say that a new or changed trigger pattern is necessary to initiate or trigger the actuation of the actuator. Possibly, the adjusted trigger pattern is selected such that the structure-borne sound signal can no longer contain the correspondingly adjusted trigger pattern, and thus no longer leads to the actuation of the actuator.

Adjusting the trigger pattern is expedient in particular if the sensor is actuated by an operator, i.e., for example by touching or approaching it with an operating hand while performing a predefined operating or actuation gesture. This is because if the trigger pattern is adjusted or changed this in particular results in a new operating gesture having to be performed for actuating the sensor, specifically compared with a previous or preceding operating gesture by means of which the trigger pattern was included in the sensor signal when the sensor signal was acquired. Adjusting the trigger pattern therefore also leads to adjustment of an operating gesture in order to operate the sensor and generate the desired trigger pattern. As a new operating gesture, a change may be made, for example, from a single click to a double click, or for example from a single click to a swipe gesture. In particular, the new operating gesture should be selected in such a way that it can possibly not be replicated by environmental influences that trigger the structure-borne sound.

In one embodiment, the sensitivity of the sensor for acquiring the sensor signal is adjusted according to the adjusted actuation condition. In particular, the sensitivity of the sensor is reduced. This means that, in particular, a higher operating force or a longer operating time is necessary when actuating the sensor, in order to generate the trigger pattern that leads to the actuation of the actuator. Combinations such as a changed sensitivity and longer actuation duration, and changes to other parameters, are also advantageous, but are not explicitly listed, for the sake of simplicity.

In one embodiment, according to the interference criterion the structure-borne sound signal is only detected as an interference signal if the structure-borne sound signal contains the predefined trigger pattern when the sensor is acted upon. That is to say that the structure-borne sound signal contains a signal course that is recognized as the trigger pattern when the sensor acquires the structure-borne sound signal. The structure-borne sound signal is then usable for, i.e., can be used for, actuating the actuator of the motor vehicle according to the predefined operating condition.

In one embodiment, the structure-borne sound signal is compared with a predefined interference threshold to check for the interference signal, and the structure-borne sound signal is only detected as an interference signal if the interference threshold is exceeded. Otherwise, i.e., if the predefined interference threshold is not met, the structure-borne sound signal is in particular not detected or identified as an interference signal. The interference threshold thus specifies a blocking threshold or limit value for the structure-borne sound signal. Below this blocking threshold, the structure-borne sound signal is not classified as an interference signal. Above this blocking threshold, however, the structure-borne sound signal is classified as an interference signal. Possibly, the check is carried out by comparing a magnitude of the respective value of the structure-borne sound signal with the interference threshold.

In one embodiment, the interference signal is reset only in a time-delayed manner, after a defined time, once the structure-borne sound signal has fallen below the predefined interference threshold again. That is to say that the interference signal remains present for a defined time period of several seconds, even if the structure-borne sound signal falls below the blocking threshold.

In one embodiment, the structure-borne sound signal is acquired in a first measurement mode with a first measurement rate or sampling rate. Only if the structure-borne sound signal exceeds a predefined measurement threshold, the structure-borne sound signal is acquired in a second measurement mode, for checking for the interference signal, with a second measurement rate or sampling rate that is higher than the first measurement rate.

Therefore, in the first measurement mode, the structure-borne sound signal is recorded with a lower resolution than in the second measurement mode. Since fewer measurements are therefore taken here, in particular a power consumption for acquiring the structure-borne sound signal is reduced. The first measurement mode can also be referred to as standby mode or idle mode. The switching between the measurement modes depends in particular on the measurement threshold being reached or exceeded. The measurement threshold can, for example, correspond to the aforementioned interference threshold. Alternatively, for example, a different, lower value than the interference threshold can be set as the measurement threshold value. It is thus possible to ensure that a switch to the faster measurement mode takes place in a timely manner. Possibly, the magnitude of the respective structure-borne sound signal value is used here too for comparison with the measurement threshold value.

In one embodiment, the structure-borne sound signal is measured using a structure-borne sound sensor which is designed to detect an absolute acceleration of the solid body of the motor vehicle. That is to say that, in addition to the sensor for acquiring the sensor signal, a further sensor is provided, namely the structure-borne sound sensor. The structure-borne sound sensor can also be referred to as a vibration sensor. For example, the structure-borne sound sensor may comprise a microphone and/or an acceleration sensor and/or a strain gauge and/or another sensor for acquiring structure-borne sound. The structure-borne sound sensor is particularly possibly provided as a MEMS (Micro-Electro-Mechanical-System).

For application cases or application situations that may arise during the method and are not explicitly described here, it may be provided that, according to the method, an error message and/or a request for input of user feedback is issued, and/or a default setting and/or a predefined initial state is set.

According to one aspect, the disclosure relates to a control device for a motor vehicle for actuating an actuator of the motor vehicle. The control device is designed to detect a predefined trigger pattern in a sensor signal, depending on the actuation of a sensor of the motor vehicle, the trigger pattern being usable for actuating the actuator according to a predefined actuation condition. That is to say that the control device can receive and evaluate the sensor signal from the sensor. The evaluation process includes, for example, checking whether the sensor signal contains the predefined trigger pattern and thus fulfills the predefined actuation condition.

Furthermore, the control device is designed to acquire a structure-borne sound signal associated with the trigger pattern, which signal propagates in a solid body of the motor vehicle. That is to say that the control device can receive the structure-borne sound signal from a corresponding sensor.

Furthermore, the control device is designed to check whether the structure-borne sound signal is present as an interference signal for activating the actuator, according to a predefined interference criterion. That is to say that the control device can receive and evaluate the structure-borne sound signal from a corresponding sensor. The evaluation comprises, for example, checking whether the structure-borne sound signal meets the interference criterion. For example, for this purpose the control device can check whether the structure-borne sound signal also contains the predefined trigger pattern. The interference signal can be output either immediately or with a time delay. For example, it is possible to have an immediate output of the interference signal and to extend the interference signal by a predefined time beyond the end of the interference criterion. Thus, in this case, the interference signal is still present for example for 2 seconds after the identified end of the interference criterion and is only then reset to the inactive state with a delay.

Only if the structure-borne sound signal is present as an interference signal, i.e., was detected as an interference signal by the control device, is the control device designed to adjust the predefined actuation condition for actuating the actuator, and to actuate the actuator depending on the adjusted actuation condition. That is to say that the control device can define the changed and adjusted actuation condition and then use it to check the sensor signal and/or the structure-borne sound signal for the respective triggering pattern. Only when the new actuation condition is met does the control device activate the actuator, causing it to be actuated. For this purpose, the control device can generate a trigger signal for the actuator and thus control the actuator, depending on whether the adjusted actuation condition is met. When the trigger signal is applied to the actuator, the actuator is actuated, i.e., it performs its predefined actuator function.

The control device thus enables the execution of one embodiment of the previously described method. The control device may for this purpose have a data processing device or a processor device (processor circuit) which is configured to carry out an embodiment of the method according to the disclosure. The processor device can have, for this purpose, at least one microprocessor and/or at least one microcontroller and/or at least one FPGA (Field Programmable Gate Array) and/or at least one DSP (Digital Signal Processor). In particular, in each case a CPU (Central Processing Unit), a GPU (Graphical Processing Unit) or an NPU (Neural Processing Unit) can be used as the microprocessor. Furthermore, the processor device can have program code that is configured to carry out the embodiment of the method according to the disclosure when executed by the processor device. The program code can be stored in a data memory of the processor device. The processor device can be based, for example, on at least one circuit board and/or at least one SoC (System on Chip).

According to one aspect, the disclosure relates to a motor vehicle with a corresponding control device as previously described. In addition to the control device, the motor vehicle may also comprise at least one sensor for acquiring or measuring the sensor signal, and at least one actuator for executing or performing an actuator or vehicle function. Furthermore, the motor vehicle may comprise at least one structure-borne sound sensor for acquiring the structure-borne sound signal.

The motor vehicle according to the disclosure is possibly designed as an automobile, in particular as a passenger car or truck, or as a passenger bus or motorcycle.

The disclosure also includes developments of the control device according to the disclosure and the motor vehicle according to the disclosure, which have features as have already been described in connection with the developments of the method according to the disclosure. For this reason, the corresponding developments of the control device according to the disclosure and the motor vehicle according to the disclosure are not described again here.

The disclosure also comprises combinations of the features of the described embodiments. The disclosure therefore also comprises implementations that each have a combination of the features of a plurality of the described embodiments, provided that the embodiments have not been described as mutually exclusive.

### BRIEF DESCRIPTION OF THE DRAWINGS

Embodiments of the disclosure are described in the following. In the figures:

FIG. 1 shows a schematic representation of a motor vehicle in a car wash, with a control device for actuating an actuator of the motor vehicle;

FIG. 2 shows a schematic representation of a graph with a sensor signal by way of example from a sensor of the motor vehicle, which signal can be evaluated for the actuation of the actuator;

FIG. 3 shows a schematic representation of a graph with a structure-borne sound signal by way of example, which can propagate in a solid body of the motor vehicle due to vibrations of the car wash, and can interfere with the evaluation of the sensor signal according to FIG. 2; and

FIG. 4 shows a schematic flowchart for a method for actuating the actuator of the motor vehicle, according to FIG. 1.

### DETAILED DESCRIPTION

The embodiments described below are preferred embodiments of the disclosure. In the embodiments, the described components of the embodiments each represent individual features of the disclosure that are to be considered independently of one another and which develop the disclosure independently of one another in each case. Therefore, the disclosure is intended to also comprise combinations of the features of the embodiments other than those shown. Furthermore, the described embodiments can also be supplemented by further features of the disclosure already described.

In the figures, identical reference signs denote functionally equivalent elements in each case.

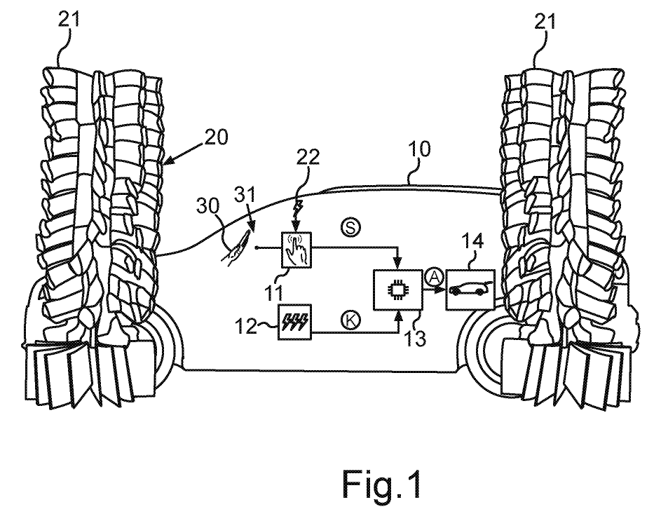

FIG. 1 shows a schematic representation of a motor vehicle 10. For example, the motor vehicle 10 is designed as a passenger car. The motor vehicle 10 comprises a sensor 11, which in the present case is designed, for example, as a touch sensor. The sensor 11 detects a sensor signal S when actuated, in particular when touched. The actuation can occur, for example, by an operator, in particular by their operating hand 30, by performing a predefined operating gesture 31. It is therefore a tactile sensor. The sensor 11 can, for example, have a force sensor, which in particular comprises a strain gage for actuation measurement. Of course, other embodiments of the sensor 11 are also conceivable, such as with a capacitive sensor, a seismic sensor or another type of sensor for touch or proximity recognition. The sensor 11 is in particular arranged or attached externally to the vehicle, i.e., on an outside of the motor vehicle 10. For example, the sensor may be integrated into a logo on the tailgate.

Furthermore, the motor vehicle 10 comprises a structure-borne sound sensor 12. The structure-borne sound sensor 12, also called vibration sensor, measures the structure-borne sound (structure-borne sound signal K), i.e., vibrations, which propagate in the solid body of the motor vehicle 10 when the motor vehicle 10 is exposed to certain environmental influences, for example. For example, the structure-borne sound sensor 12 can comprise a force sensor with an additional strain gage or an acceleration sensor. For example, a microphone is also suitable as a corresponding structure-borne sound sensor 12. Possibly, the structure-borne sound sensor 12 is designed as a MEMS sensor system.

Furthermore, the motor vehicle 10 comprises a control device 13. The control device can be designed as a data processing device for the motor vehicle 10. For this purpose, the control device 13 can for example comprise one or more microprocessors or microcontrollers. The control device 13 receives and processes the sensor signal S and the structure-borne sound signal K. The processing can comprise, for example, the evaluation of the respective signals. This includes, for example, detecting a predefined trigger pattern M in the sensor signal S, and checking whether the structure-borne sound signal K is present as an interference signal X.

Furthermore, the motor vehicle 10 comprises an actuator 14. In the present case, the actuator 14 is in particular an electrically or electronically controllable vehicle component of the motor vehicle 10, which performs an assigned vehicle function when actuated or controlled with a trigger signal A. That is to say that the actuator 14 is actuated or operated when the trigger signal A is applied thereto. In the present embodiment, the actuator 14 is designed, for example, as a tailgate opening system for the motor vehicle 10. For this purpose, the actuator 14 comprises, for example, an electric door drive, in particular an electric motor, with which the tailgate of the motor vehicle 10 can be opened or closed when appropriately controlled. As an alternative to the embodiment shown, the actuator 14 could, for example, be a door opening system for another of the vehicle doors of the motor vehicle.

The actuator 14 is controlled by the control device 13, and specifically depending on the evaluation of the sensor signal S and the structure-borne sound signal K. The conditions under which the control takes place, and how the evaluation of the signals can be implemented, will be described in more detail later.

In the embodiment shown in FIG. 1, the motor vehicle 10 is in a car wash 20 and is being washed, for example with its washing brushes 21. By treating the motor vehicle 10 with the washing brushes 21, the motor vehicle 10 is subjected to a corresponding structure-borne sound signal K. The vibrations generated as a result can act as an interference 22 or environmental influence on the actuation of the sensor 11. In particular, this can cause sensor 11 to falsely trigger actuation of the actuator 14. The sensor 11 or the control logic (control device 13) are simply unable to distinguish between the washing brushes 21 or other corresponding environmental influences, and an operator input. Switches, buttons, or handles containing such sensors are also potentially triggered by such environmental influences and should be installed in a hidden or protected manner, so that they are not automatically also cleaned in a car wash 20. Especially in the case of sensors that work with pure force sensors, such as strain gage-based sensors, it is often not possible to distinguish a pressure that was triggered, for example, by the washing brush 21. The bandwidth of the mechanical signal is often insufficient for this, or there is no dead mass that is excited by the sensor 11. In order to prevent false actuation due to environmental influences, in the present case the structure-borne sound, i.e., the structure-borne sound signal K, which is coupled into the body of the motor vehicle 10, is recognized and, depending on this, an actuation condition for the actuation of the actuator 14 is changed or adjusted.

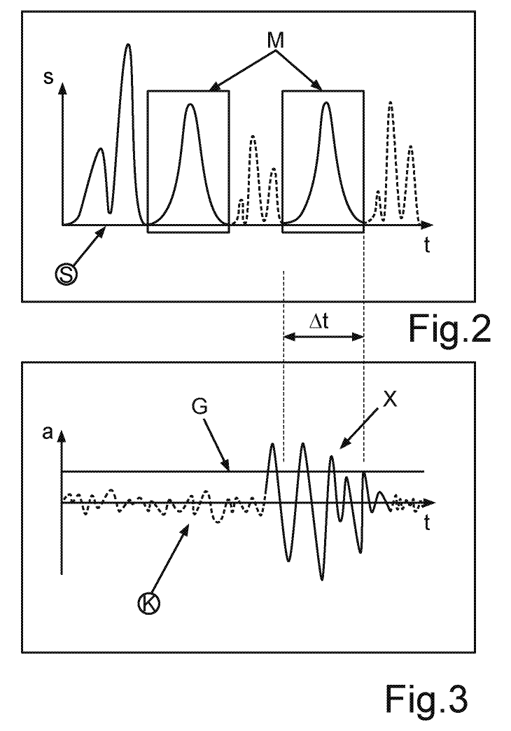

FIG. 2 and FIG. 3 are schematic graphs of the sensor signal S and the structure-borne sound signal K, as they can be received and evaluated by the control device 13. FIG. 2 shows a signal course, by way of example, of the sensor signal S in a path (s)-time (t) graph. That is to say that the actuation path s of the sensor S is shown against time t, due to the application of force, i.e., the actuation by the operator, which the sensor 11 acquires, for example. In the present embodiment, the signal course contains two portions at different time points, which can be detected or identified by the control device 13 as a predefined trigger pattern M. The trigger pattern M is a signal component or portion in the sensor signal S that leads to the activation or actuation of the actuator. The conditions under which this is the case are predefined in the actuation conditions. In the present case, the respective pattern or the course of the triggering pattern may be predefined according to the actuation condition, for example. That is to say that the trigger pattern M predefines an amplitude and duration for the sensor signal S, and thus accordingly also for the operator input, in order to generate the trigger pattern M. For detecting the trigger pattern M in the sensor signal S, the control device 13 can, for example, apply a pattern recognition algorithm to the sensor signal S.

FIG. 3 shows a graph corresponding to a signal curve, by way of example, of the structure-borne sound signal K, in an acceleration (a)-time (t) graph. That is to say that the acceleration a is plotted against time t, which acceleration is acquired by the structure-borne sound sensor 12, for example. As shown in FIG. 3, the structure-borne sound signal K contains a signal component that the control device 13 can identify as an interference signal X. For this purpose, an interference threshold value G is predefined in the present case. When evaluating the structure-borne sound signal K, the control device 13 compares, in particular, the structure-borne sound signal K, possibly its magnitude, with the interference threshold value G. If the magnitude of the structure-borne sound signal K exceeds this blocking threshold, i.e., the interference threshold value G, the control device 13 identifies the structure-borne sound signal K as an interference signal X. Specifically, when applied to the sensor 11, this interference signal X also leads to the trigger pattern M and could thus cause a false triggering of the actuator 14. The interference signal X is thus assigned to one of the trigger patterns M. That is to say that the interference signal X occurs in a given time interval Δt, in the present case in particular simultaneously or overlapping with one of the trigger patterns M. In particular, the interference signal X causes one of the trigger patterns M.

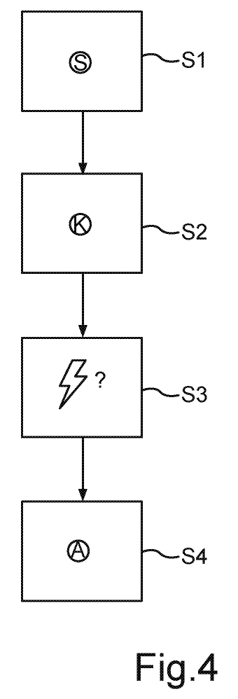

In order to now prevent such possible false activation of the actuator 14, specifically due to environmental influences, such as the car wash 20 in the present case, the structure-borne sound is detected via the additional structure-borne sound sensor 12, which is present in addition to the sensor 11, and the actuation condition for the actuation of the actuator is adjusted or changed depending on the evaluation of the two signals. FIG. 4 is again, by way of example, a process flow diagram for a method for actuating the actuator 14, in particular for operating the control device 13, in order to adjust the actuation condition.

For this purpose, in a step S1 the control device 13 first detects the predefined trigger pattern M in the sensor signal S depending on the actuation of the sensor 11. In this case, the trigger pattern M can be used to actuate the actuator 14 according to the predefined actuation condition. In a normal operating mode, the trigger pattern M would therefore lead to the activation or actuation of the actuator 14. In the present case, the detection comprises in particular that the control device 13 receives the sensor signal S from the sensor 11 and then evaluates it as described above by way of example.

The method is then continued in a step S2. In step S2, the control device 13 acquires or receives the structure-borne sound signal K associated with the trigger pattern M, which signal propagates in the solid body, i.e., for example in the body of the motor vehicle 10. The acquisition process comprises in particular the reception of the structure-borne sound signal K by the structure-borne sound sensor 12.

The method is then continued in a step S3. In step S3, the structure-borne sound signal K is evaluated. Here, the control device 13 checks whether the structure-borne sound signal K is present as an interference signal X for the actuation of the actuator 14, according to a predefined interference criterion, i.e., for example the previously described comparison with the blocking threshold G.

The method is continued in a step S4 only in the event that the interference signal X was detected. In step S4, the control device 13 adjusts the predefined actuation condition for the actuation of the actuator 14. That is to say that the actuation condition is changed, and specifically in particular such that the structure-borne sound signal K, in particular the interference signal X, is no longer detected as a trigger pattern when the sensor 11 is acted upon. The control device 13 can switch from a normal operating mode (previous actuation condition) to an interference mode (adjusted actuation condition) for evaluating the signals S, K.

Adjusting the actuation condition can, for example, comprise preventing, i.e., deactivating, the actuation of the actuator 14. The actuator 14 can then no longer be controlled by the trigger signal M for executing the vehicle function. Alternatively, the predefined trigger pattern M can be adjusted or changed. That is to say that a new template for detecting the trigger pattern M is stored. The sensor device 13 then uses the new or adjusted trigger pattern to evaluate the sensor signal S. By adjusting the trigger pattern M, an adjusted actuation pattern, i.e., an actuation gesture 31 for actuating the sensor 11, is also necessary. For example, it is possible to switch from a single click to a double click. This change in the operating gesture 31 can be communicated or displayed to the operator, for example via an HMI (Human-Machine-Interface), such as a display or a mobile terminal.

Another way to adjust the actuation condition could be, for example, to adjust the sensitivity of sensor 11, in particular to reduce it. This necessitates a higher operating force or operating duration, in order that the trigger pattern M occurs in the sensor signal S and thus the actuator actuation can be triggered. For this purpose, for example a sampling rate at which the control device 13 queries or samples the sensor signal S acquired by the sensor 11 can be reduced. For example, the control device 13 then continuously acquires the sensor signal S only every 10 µs or less, such that only a lower power consumption is necessary.

For the event that the structure-borne sound signal K is, in contrast, not detected as an interference signal X in step S3, possibly no adjustment of the actuation conditions takes place. Therefore, the detection of the originally predefined trigger pattern M leads to the actuation of the actuator 14.

The structure-borne sound sensor 12 particularly possibly records the structure-borne sound signal K only after a predefined force threshold value has been exceeded. In particular, only as long as the force, i.e., the structure-borne sound, which exceeds this force threshold is present, i.e., acts on the motor vehicle 10. This makes it possible to ensure very low power consumption of the structure-borne sound sensor 12. Alternatively or additionally, it is conceivable, for example, that the structure-borne sound sensor 12 initially measures in the background with low power consumption. The sensor is therefore in an idle or standby mode. It then wakes up by a certain threshold value or measurement threshold value being exceeded, and switches into a faster measurement mode with a higher sampling rate. In the faster measurement mode, the structure-borne sound signal K is then queried by the control device 13 or signaled for example via a wake-up pin, for example cyclically, for example every 5, 10 or 20 ms. The control device 13 can then briefly start up or increase the sampling rate of the structure-borne sound measurement and, after validation of the interference, i.e., when the interference signal X was detected, for example switch the sensor 11 to a car wash mode or interference mode. This mode is then possibly maintained for a predefined time interval, for example 20 or 30 seconds, in order to suppress unwanted opening or triggering of the respective actuator. Possibly, during validation of the interference a check is also made, for example, as to whether the interference signal X is present for a predefined period of time, for example 0.5 seconds or longer. Only then does the system switch into the interference mode, for example.

Overall, the embodiments thus show a sensor concept for a tactile operating point.

### LIST OF REFERENCE SIGNS

10 motor vehicle

11 sensor

12 structure-borne sound sensor

13 control device

14 actuator

20 car wash

21 washing brushes

22 interference

30 operating hand

31 operating gesture

A trigger signal

a acceleration

G blocking threshold

K structure-borne sound signal

M trigger pattern

S sensor signal

S1-S4 step

s path

t time

X interference signal

1. A method for actuating an actuator of a motor vehicle, comprising the following steps:
detecting a predefined trigger pattern in a sensor signal, depending on an actuation of a sensor of the motor vehicle, wherein the trigger pattern can be used for actuating the actuator according to a predefined actuation condition;
acquiring a structure-borne sound signal associated with the trigger pattern, which signal propagates in a solid body of the motor vehicle;
checking whether the structure-borne sound signal is present as an interference signal for the actuation of the actuator, according to a predefined interference criterion, wherein:
only if the structure-borne sound signal is present as an interference signal: adjusting the predefined actuation condition for actuating the actuator, and actuating the actuator only depending on the adjusted actuation condition.

2. The method according to claim 1, wherein actuation of the actuator is prevented according to the adjusted actuation condition.

3. The method according to claim 1, wherein the predefined trigger pattern is adjusted according to the adjusted actuation condition, and the actuator is actuated only if the adjusted trigger pattern is detected.

4. The method according to claim 1, wherein the sensitivity of the sensor is adjusted according to the adjusted actuation condition.

5. The method according to claim 1, wherein, according to the interference criterion, the structure-borne sound signal is only detected as an interference signal if the structure-borne sound signal contains the predefined trigger pattern when the sensor is acted upon.

6. The method according to claim 1, wherein the structure-borne sound signal is compared with a predefined interference threshold to check for the interference signal, and the structure-borne sound signal is only detected as an interference signal if the interference threshold is exceeded.

7. The method according to claim 6, wherein the interference signal is reset only after a time delay, following a defined time, after the structure-borne sound signal has fallen below the predefined interference threshold again.

8. The method according to claim 1, wherein the structure-borne sound signal is acquired in a first measurement mode with a first measurement rate, and only if the structure-borne sound signal exceeds a predefined measurement threshold, said signal is recorded in a second measurement mode, to check for the interference signal, with a second measurement rate higher than the first measurement rate.

9. The method according to claim 1, wherein the structure-borne sound signal is measured by means of a structure-borne sound sensor which is designed to detect an absolute acceleration of the solid body of the motor vehicle.

10. A control device for a motor vehicle for actuating an actuator of the motor vehicle, which is configured to:
detect a predefined trigger pattern in a sensor signal depending on an actuation of a sensor of the motor vehicle, wherein the trigger pattern can be used for actuating the actuator according to a predefined actuation condition;
acquire a structure-borne sound signal associated with the trigger pattern, which signal propagates in a solid body of the motor vehicle;
check whether the structure-borne sound signal is present as an interference signal for the activation of the actuator, according to a predefined interference criterion; and
only if the structure-borne sound signal is present as an interference signal: adjust the predefined actuation condition for the actuation of the actuator, and actuate the actuator only depending on the adjusted actuation condition.

11. A motor vehicle having a control device according to claim 10.

12. A method for actuating an actuator of a motor vehicle, comprising the following steps:
detecting a predefined trigger pattern in a sensor signal, depending on an actuation of a sensor of the motor vehicle, wherein the trigger pattern can be used for actuating the actuator according to a predefined actuation condition;
acquiring a structure-borne sound signal associated with the trigger pattern, which signal propagates in a solid body of the motor vehicle;
checking whether the structure-borne sound signal is present as an interference signal for the actuation of the actuator, according to a predefined interference criterion, wherein:
only if the structure-borne sound signal is present as an interference signal: adjusting the predefined actuation condition for actuating the actuator, and adjusting the sensitivity of the sensor according to the adjusted actuation condition.
